(19) United States
(12) Patent Application Publication
(10) Pub. No.: US 2010/0326077 A1
(43) Pub. Date: Dec. 30, 2010

(54) SYSTEM FOR MITIGATING A FUEL SYSTEM TRANSIENT

(75) Inventor: David A. Snider, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/493,716

(22) Filed: Jun. 29, 2009

(51) Int. Cl. F02C 7/22

(52) U.S. Cl. 60/734

(57) ABSTRACT

The present invention takes the form of a system that may reduce the effect of a transient of a fuel system. Essentially, an embodiment of the present invention incorporates a pressure control cell (PCC) with the fuel system. The PCC may be considered an additional volume that removes some of the fuel remaining in the fuel system during a transient event. During a transient event, when a rapid reduction of fuel is required for a fuel circuit, fuel may be allowed to exit a manifold of the fuel system and enter the PCC. This fuel may now be stored within the PCC and may no longer be available to the combustion can. A benefit of the present invention may be a reduced possibility of an undesired increase in rotor speed, and a lean blowout event.

This application is related to commonly-assigned U.S. patent application Ser. No. ______ [GE Docket 239283], filed ______.

### BACKGROUND OF THE INVENTION

The present application relates generally to a fuel system associated with a combustion process; and more particularly to, a system for mitigating an effect of a transient on the fuel system.

Fuel systems are associated with a wide-variety of combustion processes of a machine. The fuel system generally serves to transport a fuel, such as, but not limiting of, a natural gas, to the combustion process. The fuel system generally includes a manifold and a valve that collectively control the fuel flow to the combustion process. The fuel system may also control the pressure of the fuel supplied to the valve. The valve may function as the primary control of gas flow to combustion process.

A turbomachine is a non-limiting example of a machine with a combustion process. Some turbomachines, such as, but not limiting of, a gas turbine, an aero-derivative turbine, or the like, have multiple fuel systems that have at least one combustion can. These fuel systems deliver fuel to the combustion can.

Transient requirements for turbomachines, including continued operation after a transient event, are becoming increasingly demanding. During a transient event the fuel flow to the combustion process may be rapidly reduced. A transient include may include, but is not limited to, a load rejection, rapid load shedding, or the like. This may increase the likelihood of an unacceptably high speed of the turbomachine rotor. The high rotor speed may result from the fuel that remains downstream of the valve after the fuel flow is rapidly reduced. This fuel is consumed by the combustion process and may cause the rotor speed increase. Essentially, the control of the fuel flow to the combustion process lags the desired response during a transient event.

During a transient, which affects the fuel system, a known control strategy, generally involves: a) anchoring the flame to the fuel circuit that can sustain the post-transient condition; and b) rapidly reducing the fuel flow to other fuel circuits, if applicable. This strategy involves rapidly reducing the total fuel flow, while attempting to avoid a lean blowout of the combustion can. Due to the compressible volumes of gas fuel remaining in the fuel circuits, after the fuel is rapidly reduced, significant fuel flow to the combustion process may continue. After the transient event, this remaining fuel is combusted, may drive the turbomachine towards an overspeed condition, and may also increase airflow to the combustion can, which may cause a lean blowout.

There are a few disadvantages of using known systems and control philosophies during a transient event. Known systems may have a fuel system that responds relatively slowly during the transient event. Furthermore, some known systems may allow too much air to enter the turbomachine during the transient, increasing the lean blowout risk.

For the aforementioned reasons, there may be a desire for a system for mitigating the effects of a transient on the fuel system. The system should allow for a faster fuel system response during the transient event. The system should also mitigate the risk of an overspeed condition and a lean blowout.

### BRIEF DESCRIPTION OF THE INVENTION

In accordance with an embodiment of the present invention, a system for mitigating a transient experienced by a fuel system, the system comprising: a primary fuel circuit configured for delivering a fuel to a combustion process, wherein the primary fuel circuit comprises: a valve configured for controlling a flow of the fuel; and a primary manifold configured for apportioning the fuel to components of the combustion process; wherein the primary manifold is located downstream of the valve; and a pressure control cell (PCC) configured for relieving the pressure within the primary manifold during a fuel system transient; wherein the PCC removes a potion of the fuel within the primary manifold during the fuel system transient and mitigates the effect of the fuel system transient on the fuel system.

In accordance with another embodiment of the present invention, a system for mitigating a transient experienced by a turbomachine, the system comprising: a turbomachine comprising a combustion can and a fuel system adapted for delivering a fuel to the combustion can; wherein the fuel system comprises: a first fuel circuit configured for supplying the fuel to the combustion can, wherein the first fuel circuit comprises: a device configured for controlling a flow of the fuel; and a first manifold configured for apportioning the fuel to components of the combustion can; wherein the first manifold is located downstream of the device: and a pressure control cell (PCC) configured for reducing the pressure within the first manifold during a fuel system transient; wherein the PCC removes a potion of the fuel within the primary manifold during the fuel system transient and mitigates the effect of the fuel system transient on the fuel system.

### BRIEF DESCRIPTION OF THE DRAWING

FIG. 1 is a schematic illustrating the environment in which an embodiment of the present invention operates.

FIG. 2 is a schematic illustrating an example of the fuel supply system associated with the turbomachine illustrated in FIG. 1.

FIGS. 3A to 3C, collectively FIG. 3, are graphs illustrating an example of an operation of the fuel supply system illustrated in FIG. 2, during a transient event.

FIG. 4 is a schematic illustrating an embodiment of a pressure control cell system integrated with a fuel supply system, in accordance with an embodiment of the present invention.

FIGS. 5A to 5C, collectively FIG. 5, are graphs illustrating an example of an operation of the pressure control cell system of FIG. 4, during a transient event, in accordance with an embodiment of the present invention.

### DETAILED DESCRIPTION OF THE INVENTION

Certain terminology is used herein for convenience only and is not to be taken as a limitation on the invention. For example, words such as “upper,” “lower”, “left”, “front”, “right”, “horizontal”, “vertical”, “upstream”, “downstream”, “fore”, “aft”, “top”, “bottom”, “upper”, and “bottom” merely describe the configuration shown in the FIGS. Indeed, the components may be oriented in any direction and the terminology, therefore, should be understood as encompassing such variations unless specified otherwise.

As used herein, an element or step recited in the singular and preceded with “a” or “an” should be understood as not excluding plural elements or steps, unless such exclusion is explicitly recited. Furthermore, references to “an embodiment” of the present invention are not intended to exclude additional embodiments incorporating the recited features.

The present invention takes the form of a system that may reduce the effect of a transient of a fuel system. The following discussion focuses on an embodiment of the present invention integrated with a fuel system of a turbomachine, such as, but not limiting of, a gas turbine having a combustion can. Other embodiments of the present invention may be integrated with other fuel systems that require mitigation of the effects of a transient event.

Essentially, an embodiment of the present invention incorporates a pressure control cell (PCC) with the fuel system. The PCC may be considered an additional volume that is part of a system that removes some of the fuel remaining in the fuel system during a transient event. During a transient event, when a rapid reduction of fuel is required for a fuel circuit, fuel may be allowed to exit a manifold of the fuel system and enter the PCC. This fuel may now be stored within the PCC and may no longer be available to the combustion can. A benefit of the present invention may be a reduced possibility of an undesired increase in rotor speed, and a lean blowout event from occurring.

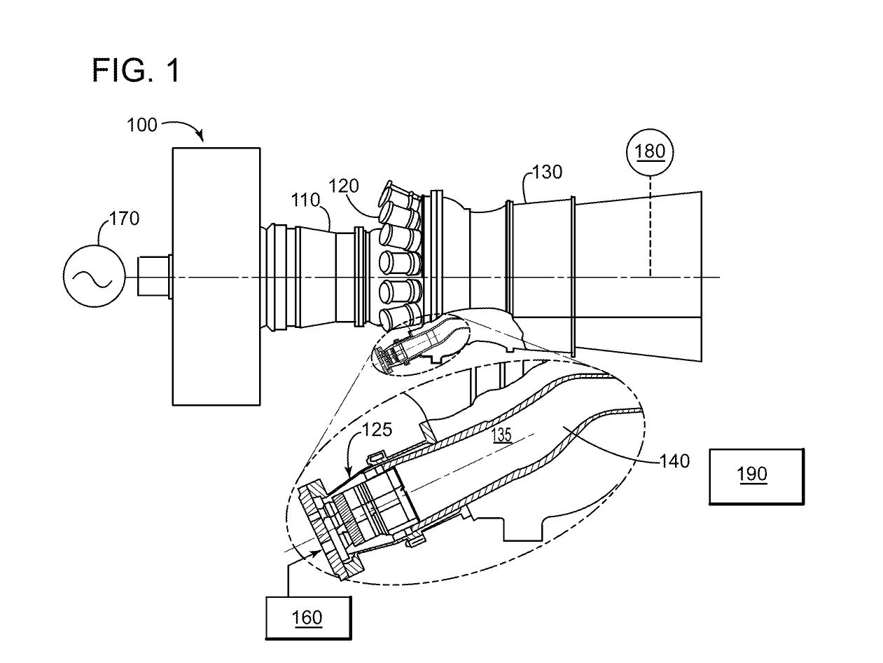

Referring now to the FIGS., where the various numbers represent like parts and/or elements throughout the several views, FIG. 1 is a schematic illustrating the environment in which an embodiment of the present invention operates. In FIG. 1, a turbomachine 100 includes: a compressor section 110; a plurality of combustion cans 120 of a combustion system, with each can 120 comprising fuel nozzles 125; a turbine section 130; and a flow path 135 leading to a transition section 140. A fuel supply system 160 may provide a fuel, such as, but not limiting of, a natural gas, to the combustion system.

Generally, the compressor section 110 includes a plurality of inlet guide vanes (IGVs) and a plurality of rotating blades and stationary vanes structured to compress a fluid. The plurality of combustion cans 120 may be coupled to the fuel supply system 160. Within each combustion can 120 the compressed air and fuel are mixed, ignited, and consumed within the flow path 135, thereby creating a working fluid.

The flow path 135 of the working fluid generally proceeds from the aft-end of the fuel nozzles 125 downstream through the transition section 140 into the turbine section 130. The turbine section 130 includes a plurality of rotating and stationary components, neither of which are shown, that convert the working fluid to a mechanical torque, which may be used to drive a load 170, such as, but not limiting of, a generator, mechanical drive, or the like. The output of the load 170 may be used by a turbine control system 190, or the like, as a parameter to control the operation of the turbomachine 100. Exhaust temperature data 180 may be also used by a turbine control system 190, or the like, as a parameter to control the operation of the turbomachine 100.

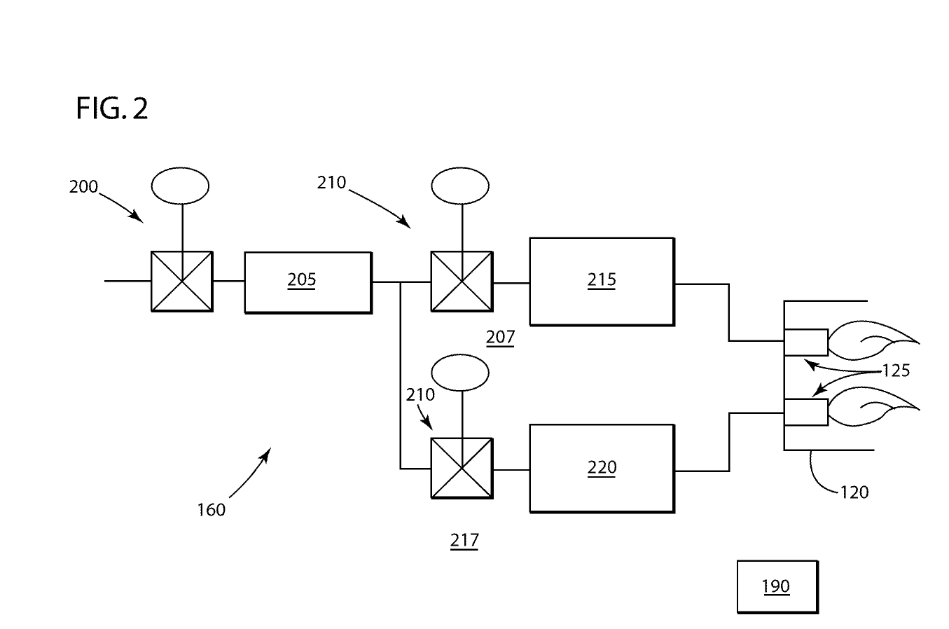

FIG. 2 is a schematic illustrating an example of the fuel supply system 160 associated with the turbomachine 100 illustrated in FIG. 1. An example of the fuel supply system 160 comprises a stop valve 200 having an upstream end that receives the fuel. The stop valve 200 generally regulates the pressure of the fuel supply system 160. A downstream end of the stop valve 200 may be directly or indirectly connected to an upstream end of an intermediate volume 205, which may be referred as a “P2 volume”. The intermediate volume 205 and the stop valve 200 may operatively function as a pressure regulator of the fuel supply system 160.

A fuel circuit may be considered the components and structures within the fuel supply system 160 that deliver the fuel to the fuel nozzles 125. As illustrated in FIG. 2, some turbomachines 100 may comprise multiple fuel circuits. The present invention is not intended to be limited to a turbomachine 100 comprising multiple fuel circuits. An embodiment of the present invention may be used with a turbomachine 100 comprising a single fuel circuit. Furthermore, the present invention is not intended to be limited to for use on a turbomachine 100. An embodiment of the present invention may apply at any machine comprising a single or multiple fuel circuits.

FIG. 2 illustrates a non-limiting example of a primary circuit 207 of the fuel supply system 160. Here, the primary circuit 207 may comprise a control valve 210 and a primary manifold 215. The control valve 210 may receive the fuel from the intermediate volume 205. The control valve 210 may also control the flow of the fuel entering the primary manifold 215, which generally serves to distribute the received fuel to some of the fuel nozzles 125.

The additional circuit 217 may have a similar general configuration as the primary circuit 207. Here, the additional circuit 217 may comprise a control valve 210 and an additional manifold 220. As described, The control valve 210 may control the flow of the fuel entering the additional manifold 220, which generally serves to distribute the received fuel to some of the fuel nozzles 125 of the combustion can 120.

Typically, a turbomachine 100, comprising multiple fuel circuits, may utilize a fuel staging process, which essentially ports fuel to a designate circuit at particular operational ranges. For example, but not limiting of the primary circuit 207 may receive fuel for the majority of a loading range, while additional circuit(s) 217 may only receive fuel during higher loading ranges. Furthermore, there may be operational ranges when both fuel circuits 207, 217 receive fuel, such as, but not limiting of, baseload operation.

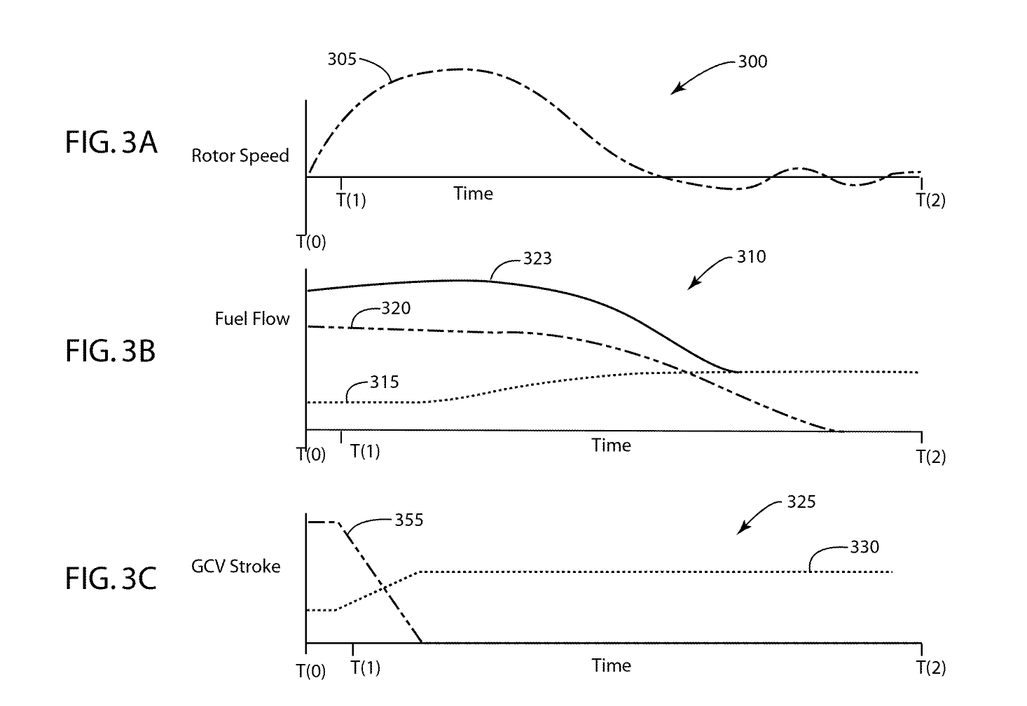

FIGS. 3A to 3C, collectively FIG. 3, are graphs illustrating an example of an operation of the fuel supply system 160 illustrated in FIG. 2, during a transient event. A transient event may be detected by the turbine control system 190. The control valves 190 of the primary circuit 207 and the additional circuit 217 begin to close to reduce fuel flow. As this occurs, pressure within the primary and the additional manifold 215, 220 is reduced from the fuel flow exiting the manifolds 215, 220 through the nozzle effective area associated with the fuel nozzles 125. The fuel flow is driven by the pressure difference between the manifold and the combustion can 120.

The control system 190 also controls the fuel flow with an aim of reducing the possibility of an undesired increase in the speed of the rotor. The undesired increase in rotor speed tends to drive more airflow, leading to a reduction in the fuel-to-air (F/A) ratio, which may make a lean-blowout of the combustion system more likely. Therefore, by reducing the amount of the rotor speed increase, the likelihood of a lean-blowout event may be significantly reduced.

Collectively FIG. 3 illustrates operational parameters of the turbomachine 100 versus time during a transient event. These operational parameters may be generally considered operational data 180. The horizontal time axis of FIG. 3 includes three specific periods, which are, in sequential order: T(0), T(1) and T(2). T(0) may be considered the time when the transient event occurs. T(1) may be considered the time when the turbine control system 190 responds to the transient event. T(2) may be considered the time when the turbomachine 100 arrives at a nearly steady state operation.

FIG. 3A is a chart 300 illustrating the rotor speed of the turbomachine 100 versus time. Here, the rotor speed is represented by a speed_1 data series 305. FIG. 3B is a chart 310 illustrating the fuel flow of the turbomachine 100 versus time. Here, the fuel flow of the primary manifold 215 is represented by a PF_1 data series 315; the fuel flow of the additional manifold 220 is represented by an AF_1 data series 320; and the total fuel flow is represented by a TF_1 data series 323. FIG. 3C is a chart 325 illustrating the control valve stroke of the turbomachine 100 versus time. Here, the position of the control valves 210, of the primary circuit 207 and the additional circuit 217 is respectively represented by a PS_1 data series 330; and the fuel flow of the additional manifold 220 is represented by an AS_1 data series 335. As illustrated throughout FIG. 3, the rotor speed greatly increases well after the turbine control system 190 begins to respond to the transient event. At time T(1) the acceleration of the rotor continues, although the fuel flow and control valve stroke decrease. As described, this continued acceleration of the rotor might be due to the fuel remaining in the manifold(s) of the fuel supply system 160, which is then burned in the combustion can 120.

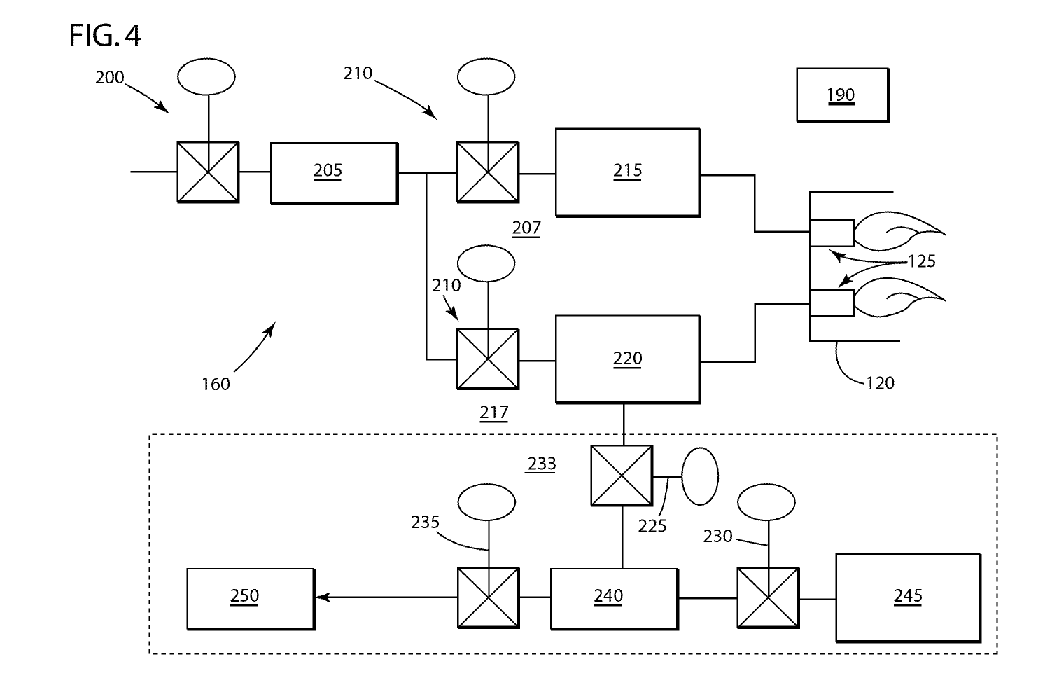

FIG. 4 is a schematic illustrating an embodiment of a pressure control cell system 223 integrated with a fuel supply system 160, in accordance with an embodiment of the present invention. An embodiment of the pressure control cell system 223 may be integrated with a variety of fuel supply system 160, including those not illustrated in FIGS. 2 and 4. The discussion below focuses on a non-limiting embodiment of the pressure control cell system 223 integrated with the fuel supply system 160 discussed in FIGS. 2 and 4.

Essentially, an embodiment of the present invention integrates an independent volume, a primary control cell (PCC) 240, with the fuel supply system 160. Fuel flow into and out of the PCC 240 may be controlled by at least one valve. The PCC 240 may be initially filled with a fluid such as, but not limiting of, an inert gas, air, or combinations thereof, at a pressure close to ambient. During a transient event, an embodiment of the present invention may allow the fuel to flow from a fuel manifold to the PCC 240.

An embodiment of the present invention may provide a valve, which controls the flow into the PCC 240, having a much larger effective area than that of the fuel nozzles 125. This feature may allow for the respective manifold pressure to be reduced relatively faster than other known systems. This feature may also allow the pressure in the PCC 240 to increase, while pressure of the fuel manifold decreases. The fuel volume that is now within the PCC 240 may be considered the energy no longer available to accelerate the rotor. An additional benefit of the present invention is that the reduced rotor acceleration may also reduce the maximum airflow, reducing the likelihood of a lean blowout event. After a steady state condition of the turbomachine 100 has been reached, the fuel from the additional volume may be slowly discharged via a fuel discharge 250.

Referring back to FIG. 4, an embodiment of the pressure control cell system 223 may comprise: a first PCC valve 225, a second PCC valve 230, a third PCC valve 235, a primary control cell (PCC) 240, a purge source 245, and a fuel discharge 250. The first PCC valve 225 generally serves to isolate the pressure control cell system 223 from the fuel supply system 160. Specifically, in an embodiment of the present invention, the first PCC valve 225 may control the flow of the fuel exiting the additional manifold 220 and entering the PCC 240. The second PCC valve 230 generally serves to isolate the PCC 240 from the purge source 245. Specifically, in an embodiment of the present invention, the second PCC valve 230 may control the flow of the purge fluid exiting the purge source 245 and entering the PCC 240. The third PCC valve 235 generally serves to isolate the PCC 240 from the fuel discharge 250. Specifically, in an embodiment of the present invention, the third PCC valve 235 may control the flow of the fuel exiting the PCC 240 and entering the fuel discharge 250.

The PCC 240 essentially serves as a temporary volume for receiving the excess fuel within a manifold, such as, but not limiting of, the primary manifold 215, or the additional manifold 220, of the fuel supply system 160. This excess fuel may be a result of the transient event, as described. The size of the PCC 240 may be customized to support a particular combustion system. For example, but not limiting of, a particular combustion system may require a PCC 240 having a volume comprising a range of from about 5 cubic feet to about 25 cubic feet.

The pressure control cell system 223 may allow for the first PCC valve 225 to be opened to an effective area many times larger than the effective area of the fuel nozzles 125. This feature may allow for most of the excess fuel, which may lead to an overspeed event, to be transferred in the volume of the PCC 240.

The purge source 245 may provide a purge fluid, such as, but not limiting of, an inert gas, air, or combinations thereof, to the PCC 240. This may provide the pressure control cell system 223 with multiple benefits. When the second PCC valve 230 is opened, the purge source 245 may allow for the purge fluid to drive the fuel out of the PCC 240. Also, the purge fluid may be used to clean or sweep the PCC 240 after the fuel is purged. This may aid in preparing the pressure control cell system 223 for a future use.

The fuel discharge 250 generally allows for the majority of the fluid within the PCC 240 to exit the pressure control cell system 223. When the third PCC valve 235 is opened the fuel and/or purge fluid within the PCC 240 to exit. The fuel discharge 250 may be in the form of a ventilation system of the like. In an embodiment of the present invention, the fuel discharge 250 may comprise a component of a system of the turbomachine 100. Here, the fuel discharge 250 may include, but is not limiting to, an exhaust system and/or the compressor inlet system of the turbomachine 100.

In use, the pressure control cell system 223 may initially flush the PCC 240 with the purge fluid. Then, the PCC valves 225, 230, and 235 may be in a closed position and the turbomachine 100 may be operating in a normal mode.

As discussed, the response by the turbine control system 190 to the transient event may be slightly delayed until operating data 180 on the transient event is received and/or until the turbine control system 190 may detect rotor acceleration and an increase in the rotor speed. After detection of the transient event, the turbine control system 190 may adjust the position of each control valve 210 of the primary and additional circuits 207, 217. For example, but not limiting of, the control valve 210 of the primary circuit 207 may be opened to anchor the flame with the goal of reducing the chance of a lean blowout event. Nearly simultaneously, the control valve(s) 210 of the additional circuit(s) 217 may be closed with the goal of reducing the fuel flow and controlling the rotor speed.

Next, after the primary circuit 207 anchors the flame, the pressure control cell system 223 may open the first PCC valve 225. As discussed, an embodiment of the first PCC valve 225 may be a valve with an effective area much larger than the effective area fuel nozzles 125. This may allow for the excess fuel remaining in the additional manifold 220 to flow into the PCC 240. This may prevent the combustion of the excess fuel in the additional manifold 220, as described.

Next, when the turbomachine 100 achieves a relatively steady state condition, the pressure with the PCC 240 and the additional manifold 220 may be nearly equal to the compressor discharge pressure. Then, the first PCC valve 225 may be closed and the third PCC valve 235 may be opened to allow the fuel within the PCC 240 to flow towards the fuel discharge 250. Then, the second PCC valve 230 may be opened and the first PCC valve 225 may be closed. This may allow for the purge fluid of the purge source 245 to flush the fuel within the PCC 240 towards the fuel discharge 250.

Next, when the pressure within the PCC 240 has decreased to a desired amount, the second PCC valve 230 and the third PCC valve 235 may then be closed. This may configured/reset the pressure control cell system 223 to a normal state.

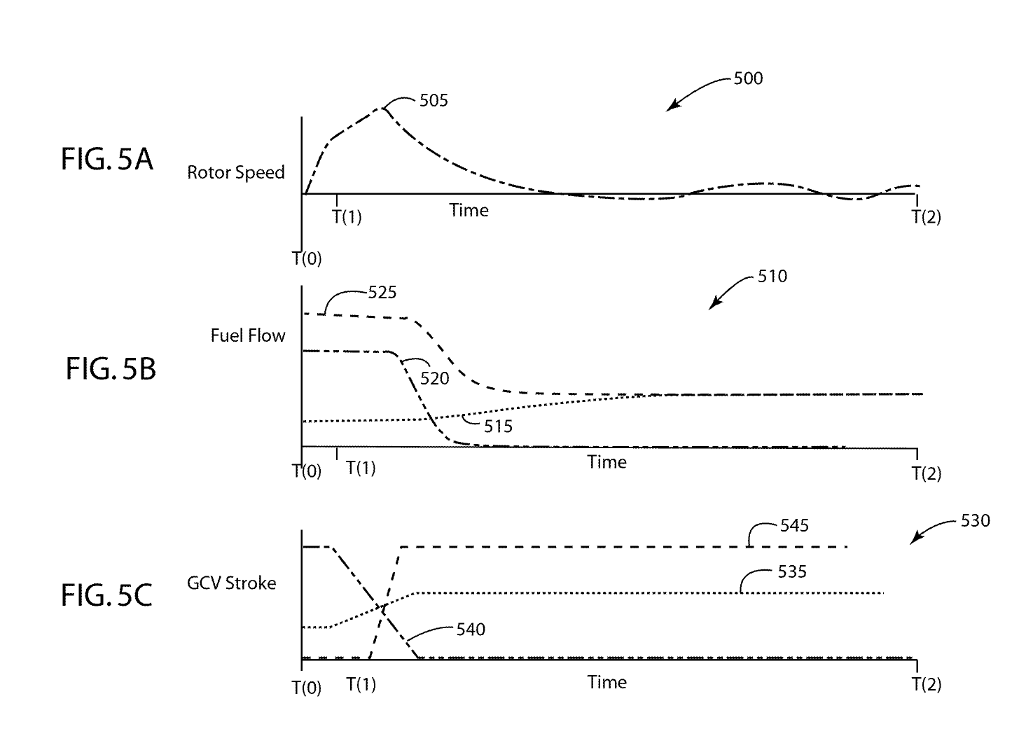

FIGS. 5A to 5C, collectively FIG. 5, are graphs illustrating an example of an operation of the pressure control cell system 223 of FIG. 4, during a transient event, in accordance with an embodiment of the present invention. Collectively FIG. 5 illustrates operational data 180 of the turbomachine 100 versus time during a transient event occurring on a turbomachine 100 equipped with an embodiment of the pressure control cell system 223 of the present invention. The horizontal time axis of FIG. 5 includes three specific periods, which are, in sequential order: T(0), T(1) and T(2). T(0) may be considered the time when the transient event occurs. T(1) may be considered the time when the turbine control system 190 responds to the transient event. T(2) may be considered the time when the turbomachine 100 arrives at a nearly steady state operation.

FIG. 5A is a chart 500 illustrating the rotor speed of the turbomachine 100 versus time. Here, the rotor speed is represented by a speed_2 data series 505. FIG. 5B is a chart 510 illustrating the fuel flow of the turbomachine 100 versus time. Here, the fuel flow of the primary manifold 215 is represented by a PF_2 data series 515; the fuel flow of the additional manifold 220 is represented by an AF_2 data series 520; and the total fuel flow is represented by a TF_2 data series 525. FIG. 5C is a chart 530 illustrating the control valve stroke of the turbomachine 100 versus time. Here, the position of the control valves 210, of the primary circuit 207 and the additional circuit 217 is respectively represented by a PS_2 data series 535; and the fuel flow of the additional manifold 220 is represented by an AS_2 data series 540. FIG. 5C also illustrates the position of the first PCC valve 225 represented as the PCC_S data series 545.

The benefits of an embodiment of the present invention are simply illustrated by like comparisons of FIG. 3 and FIG. 5. As illustrated throughout FIG. 5, the rotor speed increase is considerably less at T(1) when comparing FIGS. 3A and 5A. This may represent the decrease in the fuel burned by the additional circuit 217. Also, as shown by comparing FIGS. 3B and 5B, the total fuel flow nearly equals that of the primary circuit 207 substantially faster under an embodiment of the pressure control cell system 223.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings.

Accordingly, we intend to cover all such modifications, omissions, additions, and equivalents as may be included within the spirit and scope of the invention as defined by the following claims. For example, but not limiting of, FIGS. 2 and 4 illustrate just one additional circuit 217. Other embodiments of the present invention may be integrated with a fuel supply system 160 comprising more additional circuits 217. As another example, but not limiting of, FIGS. 2 and 4 illustrate the pressure control cell system 223 integrated with the additional circuit 217. Other embodiments of the present invention may integrate the pressure control cell system 223 with the primary circuit 207. Furthermore, other embodiments of the present invention may integrate one PCC 240 with multiple manifolds of the fuel supply system 160. Alternatively, other embodiments of the present invention have a fuel supply system 160 configured with one PCC 240 per manifold.

What is claimed is:

1. A system for mitigating a transient experienced by a fuel system, the system comprising:
a primary fuel circuit configured for delivering a fuel to a combustion process, wherein the primary fuel circuit comprises:
a valve configured for controlling a flow of the fuel; and
a primary manifold configured for apportioning the fuel to components of the combustion process; wherein the primary manifold is located downstream of the valve; and
a pressure control cell (PCC) configured for relieving the pressure within the primary manifold during a fuel system transient;
wherein the PCC removes a potion of the fuel within the primary manifold during the fuel system transient and mitigates the effect of the fuel system transient on the fuel system.

2. The system of claim 1, wherein a component of the combustion process comprises a combustion can configured for receiving a portion of the fuel.

3. The system of claim 1, wherein upstream of the primary manifold, the primary fuel circuit further comprises: a stop valve; a control valve; and an intermediate fuel volume located between the stop valve and the control valve.

4. The system of claim 3, wherein the PCC is integrated with the manifold.

5. The system of claim 3, further comprising a secondary additional circuit, wherein the secondary circuit comprises: a secondary manifold configured for receiving a portion of the fuel that is designated for the secondary circuit; and a secondary valve configured for controlling a flow of the fuel, and is located upstream of the secondary manifold.

6. The system of claim 5, wherein the PCC is integrated with the secondary manifold.

7. The system of claim 1, wherein the PCC is integrated with a purge source configured for removing a majority of the fuel from the PCC.

8. The system of claim 7, wherein the purge source comprises a storage tank comprising a fluid.

9. The system of claim 8, further comprising a fuel discharge configured for discharging the fuel purged from the PCC.

10. The system of claim 9, further comprising a PCC circuit comprising: the PCC; a first PCC valve located between the primary manifold and the PCC; a second PCC valve located between the purge source and the PCC; and a third PCC valve located between the fuel discharge and the PCC.

11. The system of claim 7, wherein the PCC comprises a volume of from about 5 cubic feet to about 25 cubic feet.

12. The system of claim 1, further comprising a turbine control system configured for controlling the operating of the PCC.

13. A system for mitigating a transient experienced by a turbomachine, the system comprising:
a turbomachine comprising a combustion can and a fuel system adapted for delivering a fuel to the combustion can; wherein the fuel system comprises: a first fuel circuit configured for supplying the fuel to the combustion can, wherein the first fuel circuit comprises:
a device configured for controlling a flow of the fuel; and
a first manifold configured for apportioning the fuel to components of the combustion can; wherein the first manifold is located downstream of the device; and
a pressure control cell (PCC) configured for reducing the pressure within the first manifold during a fuel system transient;
wherein the PCC removes a potion of the fuel within the primary manifold during the fuel system transient and mitigates the effect of the fuel system transient on the fuel system.

14. The system of claim 13, wherein upstream of the first manifold, the first fuel circuit further comprises: a stop valve; a control valve; and an intermediate fuel volume located between the stop valve and the control valve.

15. The system of claim 13, wherein the PCC is integrated with at least one manifold.

16. The system of claim 14, further comprising a second additional circuit, wherein the second circuit comprises: a second manifold configured for receiving the fuel intended for the second circuit; and a second valve configured for controlling a flow of the fuel and is located upstream of the second manifold.

17. The system of claim 16, wherein the PCC is integrated with the second manifold.

18. The system of claim 13, wherein the PCC comprises a purge source configured for removing a majority of the fuel from the PCC; and wherein the purge source comprises a storage tank comprising a fluid.

19. The system of claim 18, further comprising a fuel discharge configured for discharging the fuel purged from the PCC; wherein a location of the fuel discharge comprises a system of the turbomachine.

20. The system of claim 19, further comprising a PCC circuit comprising: the PCC; a first PCC valve located between the first manifold and the PCC; a second PCC valve located between the purge source and the PCC; and a third PCC valve located between the fuel discharge and the PCC.
